(19) United States
(12) Patent Application Publication
(10) Pub. No.: US 2010/0143427 A1
(43) Pub. Date: Jun. 10, 2010

(54) Antimicrobial Surfaces

(76) Inventors: Joseph A. King, Wayzata, MN (US); John Hill, Plymouth, MN (US)

Correspondence Address: Carl L. Johnson;Jacobson and Johnson, Suite 285, One West Water Street, St. Paul, MN, 55107, US

(21) Appl. No.: 12/592,692

(22) Filed: Dec. 1, 2009

Related U.S. Application Data
(60) Provisional application No. 61/200,957, filed on Dec. 5, 2008.

(51) Int. Cl. A01N 25/00; A01N 59/00; A01N 59/16; A01P 1/00

(52) U.S. Cl. 424/405; 424/600; 424/618

(57) ABSTRACT

An antimicrobial structure surface therein wherein the structure surface includes an antimicrobial agent having a biocidal metal ion source and compound containing a hydantoin ring wherein the compound containing the hydantoin ring may or may not have antibacterial properties but the combination of the compound containing the hydantoin ring and the biocidal metal ion source when in the presence of a liquid coact to increase the level of available metal ions for killing microorganisms on the structure surface.

### CROSS REFERENCE TO RELATED APPLICATIONS

This application claims priority from U.S. provisional application 61/200,957 filed Dec. 5, 2008 titled Biocidal Products.

### FIELD OF THE INVENTION

This invention relates generally antimicrobial surfaces and, more specifically, to antimicrobial structure surfaces having an antimicrobial agent thereon to prevent or eliminate bacteria and other harmful microorganisms on the structure surfaces.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

One of the health concerns for individuals is the presence of harmful bacteria and toxins in both a home environment and a business environment. It is known that bacteria and other microorganisms can remain in an active state on structure surfaces for an extended length of time. In addition the presence of water can cause the bacteria and other harmful microorganism to rapidly increase. As a result it becomes more likely that bacteria and other harmful microorganisms can be transferred from individual to individual through physical contact with the structure surfaces carrying the bacteria and other harmful microorganisms. In order to minimize the transfer of bacteria and other harmful microorganism through contact with structure surfaces the present invention provides antimicrobial structure surfaces that can reduce or eliminate harmful bacteria and other harmful microorganisms on structure surfaces thus limiting not only the presence of harmful bacteria and harmful microorganisms but the transfer of bacteria and harmful microorganisms.

### SUMMARY OF THE INVENTION

Briefly, the present invention comprises a method for enhancing the health and safety of structure surfaces through the use of structure surfaces containing an antimicrobial agent having a biocidal metal therein and a compound containing a hydantoin ring whereby the antimicrobial agent can kill or prevent growth of harmful microorganisms on the structure surface even in situations where the concentration of the biocidal metal in the antimicrobial agent may, when used alone, be insufficient to maintain a concentration of biocidal metal ions on the structure surfaces which is sufficient to kill bacteria and other microorganisms thereon. In one mode the antimicrobial agent in a dry or inactive can be incorporated into or placed on the structure surface and in another mode the antimicrobial agent can be applied to the structure surface with a carrier that is allowed to evaporate to leave the antimicrobial agent in an inactive state where the antimicrobial agent can be activated by the presence of a liquid.

In one example interior or exterior building structure surfaces, such as found on wallboard, fiberboard, wood laminate, roof tiles, insulation, conduits including air ducts and electrical conduits, water pipes, bathroom fixtures, bathroom surfaces, glass and doorknobs contain the antimicrobial agent.

In another example structure surfaces of cleaning products such as brooms, buckets, may be impregnated or coated with the antimicrobial agent to provide protection to the building occupants and the users.

In another example products used in buildings, namely structure surfaces found on containers such as pots, pans, bottles and the like can be impregnated or coated with the antimicrobial agent to provide protection to the users.

In another example, the structure surfaces may include liquid covering materials such as paints, varnishes or the like which contain an antimicrobial agent wherein the liquid covering material with the antimicrobial agent can be applied directly to structure surfaces such as buildings surfaces either after or before the building is erected.

In another example surface coatings may be applied to a structure surface found proximate pools, bathtubs, showers or the like to prevent growth of bacteria and other harmful microorganisms.

In another example the antimicrobial method includes applying the antimicrobial agent containing a metal ion donor and a compound contain a hydantoin ring in a liquid carrier can be applied to a structure surface with the liquid allowed to evaporate and leave the metal ion donor and the compound containing a hydantoin ring on the structure surface.

In another example the invention may includes an antimicrobial method where one forms a structure surface, applies an antimicrobial agent containing a source of metallic ions and a compound containing a hydantoin ring to the structure surface during the manufacturing process to thereby lessen or eliminate growth of bacteria and other harmful microorganisms on the structure surface.

### BRIEF DESCRIPTION OF THE DRAWINGS

FIG. 1 is a cutaway of a building showing typical structure surfaces and structure surfaces within a building that may benefit from the biocidal agent;

FIG. 2 shows an operator applying the antimicrobial agent to an exterior building surface;

FIG. 3 shows an enlarged view of a portion of a building surface with the antimicrobial agent located thereon;

FIG. 4 shows moisture in the form of a patch of water that is located on the building surface;

FIG. 5 shows a schematic of a hydantoin ring; and

FIG. 6 shows a table showing dissolved silver concentrations.

### DESCRIPTION OF THE PREFERRED EMBODIMENT

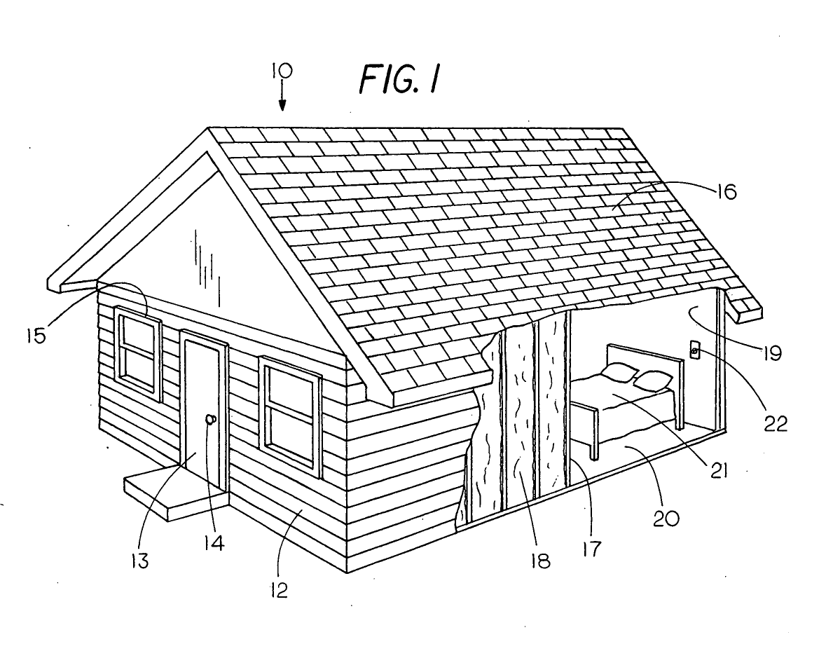

FIG. 1 is a cutaway of a building 10 revealing portions of the interior of the building and portions of the exterior of the building to illustrate examples of various types of structure surfaces that can be treated with an antimicrobial agent described herein to either kill or prevent formation of harmful bacteria and other harmful microorganisms that normally grow on the structure surface when there is moisture on the structure surfaces. Typically, the antimicrobial agent may be applied to the structure surfaces through spraying or though incorporating the antimicrobial agent directly into the structure surface during formation of the structure surface. For example, through use of an adhesive or by incorporating the antimicrobial agent directly into the structure surface.

Examples of exterior structure building surfaces which may receive the antimicrobial agent are illustrated in FIG. 1 and include siding 12, a door 13, a door knob 14 the windows 15 and the shingles 16. In addition, the antimicrobial agent may be applied to unexposed structure surfaces that are normally not exposed when a house or building is finished. For example items such as studs 17 and insulation 18 which are located between the siding 12 and the interior building wall 19 but when wet form areas where mold and other harmful microorganisms can grow. The antimicrobial agent can further be applied to interior structure surfaces of the building including ceilings and walls 19, floor 20, electrical fixtures 22 and furniture 21. As used herein structure surfaces includes those surfaces of the building that are an integral component of the building as well as the surface of those objects which may not be integral to the building but are considered part of the building, for example furniture which may be built in or may be moveable from room to room.

One of difficulties with use of biocidal metals, is that the solution that carries the antimicrobial agent on the structure surface may limit the effectiveness of the antimicrobial agent by limiting the availability of the biocidal metal ions. For example, it is known that limiting the available of biocidal metal ions may limit the effectiveness of the biocidal metal as a sanitizing agent. This is particularly true of biocidal sanitizing agents containing silver where the solubility of silver in water limits the concentration of available silver for killing bacteria. With the antimicrobial agent described herein is located a structure surface the structure surface has higher levels of metal ions than expected as a consequence of the combination of a biocidal metal source with a compound containing a hydantoin ring. Consequently, applying the antimicrobial agent to the structure surface lessens or eliminates growth of bacteria and other harmful microorganisms on the structure surface.

Another feature is that the structure surface with the antimicrobial agent thereon can remain in a passive state until wet or moist conditions occur which cause growth of bacteria and other harmful microorganisms. One of the features of the antimicrobial agent described herein is that when conditions for growth of harmful microorganisms are the greatest (i.e., when the structure surface is wet) the antimicrobial agent becomes a more effective antimicrobial agent since the presence of moisture forms a liquid carrier which increases the concentrations of available biocidal metal ions on the structure surface.

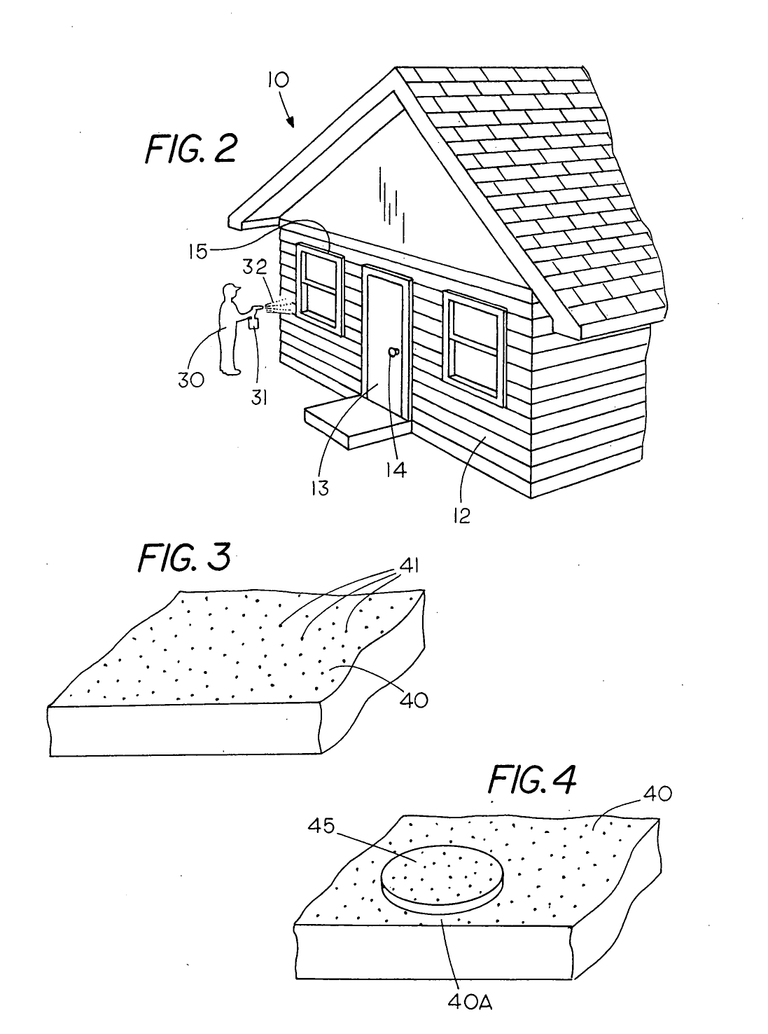

FIG. 2 shows an operator 30 applying an antimicrobial agent 32 to a building surface using a hand held sprayer 31. Spraying the antimicrobial agent on the building surface, i.e. the siding 12, is only one of many ways that the antimicrobial agent can be applied to the surface. For example, without limiting thereto the antimicrobial agent may be applied through inclusion with other liquid surface applied materials such as brush-on paints or varnishes. Other examples of application may include securing the antimicrobial agent to the structure surface through incorporation of the antimicrobial agent into the product during the manufacture of the product.

One of the aspects of the invention is that the presence of surface moisture with the antimicrobial agent increases the solubility of the biocidal metal ions and hence quickly increases the level of available metal ions and consequently the ability of the antimicrobial agent to rid the surface of bacteria and other harmful microorganisms.

FIG. 3 shows an enlarged view of a portion of a structure surface 40 wherein an antimicrobial agent 41 thereon has been applied to the structure surface 40. In one example, the biocidal sanitizing agent, which is adhered to the surface, includes silver chloride as a source of silver ions and a compound containing a hydantoin ring such as DMH. With no water present the growth of bacteria and other harmful organisms is general limited, however, once water is introduce bacteria and other harmful organisms can begin to grow rapidly. As shown in FIG. 3 the antimicrobial agent is dispersed throughout the structure surface but may have low antibacterial effect since there is no water present to act as a carrier for the silver ions. On the other hand without the presence of water there is little opportunity for the growth of bacteria and other harmful organisms.

FIG. 4 illustrates what happens when conditions for rapid growth of bacteria and other harmful microorganisms occur, namely the presence of water. In the embodiment of FIG. 4 reference numeral 45 identifies a patch of water, which is located on the surface 40. The presence of water creates conditions for the growth of bacteria and other harmful organisms. The presence of water on the surface may occur either from moisture in the air or from water being applied to the surface. In any event it creates condition for growth of mold as well as other forms of bacteria and other harmful microorganisms. As the water contacts the structure surface and the antimicrobial agent the water forms a carrier for the biocidal metal ions which can then be distributed to the area covered with water to kill bacteria and other harmful microorganisms. In addition, the presence of water also increases the solubility of the biocidal metal, which thereby increases the level of available biocidal metal ions. Biocidal metals include zinc, copper, silver and any other metals whose ions can kill bacteria or microorganisms.

FIG. 4 shows a bacteria and microorganisms killing zone of heightened biocidal activity that includes a surface region 40a within the patch of water 45 and a portion of the antimicrobial agent 41 wherein the antimicrobial agent includes a source of metal ions and a compound containing a hydantoin ring. In one example the antimicrobial agent includes a source of metal ions such as silver chloride and the compound containing the hydantoin ring is dimethylhydantoin.

Within the bacteria and microorganisms killing zone the antimicrobial agent 40 adheres to the structure surface 40 in a kill ready condition until the surface is wetted, for example by water, which causes the level of metal ions in the wetted region to increase. It will be noted that because the water acts as a carrier for the metal ions the size of the zone expands or contracts in response to size of the water wetted surface. Thus the size of bacteria killing zone may be increased by increasing the wetted area on the surface 40. Consequently, even accidental spills of water on the structure surface give rise to enhancement of the killing of bacteria and other microorganisms.

One of the limitations of the use of only a source of silver ions as an antimicrobial agent is that the solubility of the silver in water can limit the concentrations of available silver metal ions to kill the bacteria and other harmful microorganisms thus rendering the antimicrobial ineffective for a particular use. However, with the use of a biocidal metal with a compound containing a hydantoin ring one can increase the effectiveness of the antimicrobial agent because the solubility of the metal ions in the water increases in the presence of the compound containing a hydantoin ring. For example, when an unhalogenated hydantoins such as 5,5-dimethylhydantoin is used with the source of metal ions one obtains a higher level of biocidal metal ions than if antimicrobial agent were used without the 5,5-dimethylhydantoin.

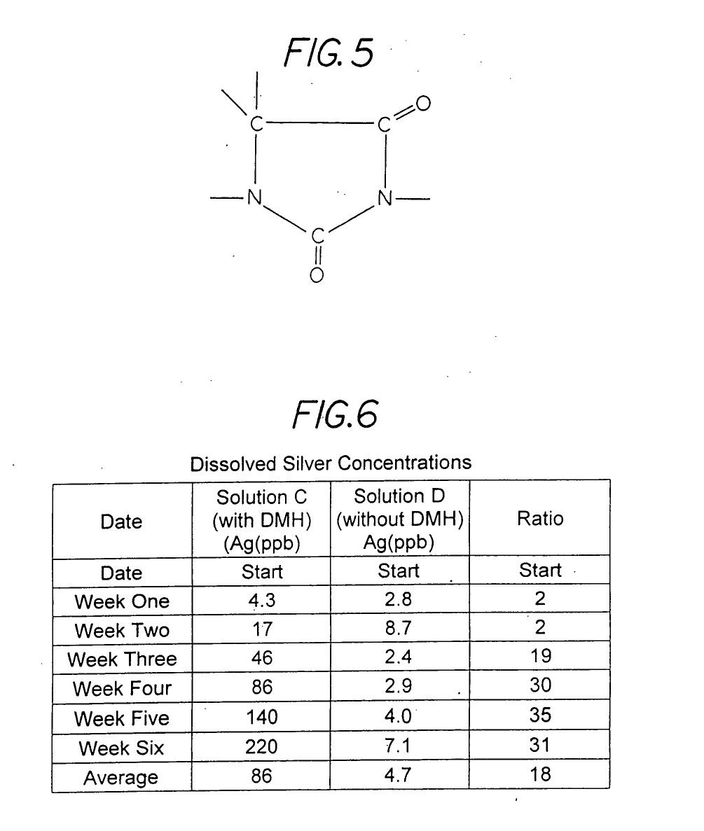

FIG. 5 shows a schematic of the structure of a hydantoin ring with carbon and nitrogen atoms joined in a five-sided ring. An oxygen atom is attached to two of the carbons in the hydantoin ring. The lines extending from the third carbon atom and the nitrogen atom indicate that other atoms could be attached thereto. For example, in a compound containing a hydantoin ring, such as DMH (5,5-dimethylhydantoin), two methyl groups would be attached to the carbon atom an a hydrogen atom would be attached to each of the two nitrogen atoms.

It has been found that compounds containing a hydantoin ring such as 5,5-dimethylhydantoin (DMH), while lacking antimicrobial properties, do have the ability to interact with metal ion donors including silver metal ion donors to increase the solubility of the silver ions in a liquid environment and thereby increase the effectiveness of the antimicrobial process. While a number of compounds with a hydantoin ring may be used as a practical matter one may want to avoid those compounds where the group or groups on the compound may have an adverse effect on the product. On the other hand one may want to include those compound containing a hydantoin ring which in themselves may have an antimicrobial effect.

Examples of other well known compounds wherein the compound contains a hydantoin ring include silver dimethylhydantoin 1-hydroxymethyl-5,5-dimethyl hydantoin, glycolyurea and Copper hydantoin, Hydantoin-5-acetic acid, and Imidazolidines including parabanic acid, 2-Thiohydantoin, hydantoin purum, hydantoin, 1-Aminohydantoin hydrochloride, 2-Imidazolidone, 2-Imidazolidone purum, 2-Imidazolidinethione, 2-hydrazino-2-imidazoline hydrobromide, 2-oxo-1-imidazolidinecarbonyl chloride, 1-methylhydantoin, 5-methylhydandtoin, 2-imidazolidone-4-carboxylic acid, allantoin, allantoin purum, creatinine anhydrous, creatinine biochemika, creatinine hydrochloride, 2-methyl-2-imidazoline, 2-methylithio-2-imdazoline hydrodide, 3-bromo-1-chlor-5-5-dimethlyhydantoin, 1-3-dibromo-5,5-dimethyl hydantoin purium, 1-3-dichlorol-5,5-dimethylhydantoin, 1,3-dichlor-5,5-di methyl hydantoin, hydantoin-5-acetic acid. 2-chlorocarbonyl-1-methanesulfonyl-2-imidazolidinone. 5,5-dimethylhydantoin purum. 5,5-dimethylhydantoin, 2-imino-1-imidaolidineacetic acid, 1,3-dimethyl-2-imidazolidinone puriss, 1,3-dimethyl-2-imidazolidinone purum, 1,3-dimethyl-2-imidazolidinone, 1-(2-hydroxyethyl)-2-imdazolinone, 1,5,5-trimethlylhydantoin, 5-ethyl-5-methylhydantoin, 2-phenyl-2-imidazoline purum, 2-(4,5-dihydro-1h-imidazoyl)-2-phenol, 4-(4,5-dihydro-1H-imidazol-2yl)phenylamine, 5-methyl-5-phentylhydantoin, 2-benzylimidazoline, 4-(4-methyl-4,5-dihydro-1H-imidazol-2-yl)phenyl, Imidazolidinyl urea, 4-hydroxymephenyloin, triethoxy-3-(2-imidazolin-1-yl)propysiliane purum, 1,(p-tosyl)-3,4,4-trimethylimidazolidine, naphazoline nitrate purisss, 5,5,diphenyl-2-thiohydantoin, 5-(4-hydroxyphenyl)-50phenylhydantion, 5-(p-methyl phenyl)-5-phenyhydantoin, 1,3,bisbensy1-2-oxoimidazoline-4,5-dicarboxylic acid. Other examples of hydantoins are listed in European patent EP0780125 which is hereby incorporated by reference. The above list compounds with a hydantoin ring is illustrative and no limitation thereto is intended.

It was found that a silver ion donor in the presence of a compound containing a hydantoin ring such as DMH has a level of free silver higher than anticipated when compared to the silver ion donor in a water environment without the DMH. The results suggest that DMH enhances the solubility of the silver thereby increasing the antimicrobial effectiveness.

In order to verify that a compound containing a hydantoin ring, such as DMH, interacts to increase the solubility of insoluble silver in a water environment, a test was performed using either silver chloride or silver bromide as the donor of silver metal ions. The test demonstrated the enhancement of silver in a water environment when DMH is used in combination with a source of silver ions.

### Example

Silver bromide was initially prepared from a saturated sodium bromide solution, combined with silver nitrate in solution. The yellow precipitate, silver bromide, was than purified by filtration and washing. Additionally, the solid was allowed to dry before use.

A buffer system having a pH of 7.41 was prepared by adding Fisherbrand® potassium phosphate monobasic-sodium phosphate dibasic buffer to 2 Erlenmeyer flasks filled with 1000 mL of purified water. The first flask was treated with 1.12 grams of 5,5-dimethylhydantoin (DMH) and marked solution “C” (with DMH) and the second flask was left untreated and marked solution “D” (without DMH) for control. In regards to the 5,5-dimethylhydantoin (DMH), the 5,5-dimethylhydantoin (DMH) comprised 97% reagent grade was obtained from Aldrich® (CAS No. 77-71-4, Cat. No. D161403-1KG).

After the initial set-up, approximately 0.10 grams of dried silver bromide was introduced into a dialysis tubing (Fisherbrand®, 45 mm, MWCO 12,000-14,000) along with purified water. The ends of the dialysis tubing were clamped to contain the silver bromide and purified water. Next, the outside of the dialysis tubing was rinsed several times to ensure that silver bromide residue was not on the outside of the dialysis tubing. A string was then tied to one clamp, and one tube was introduced into each flask. A magnetic stir bar was used to mix the solutions.

During the period of the test, a 100 ml sample were removed from solution “D” (without DMH) and solution “C” (with DMH) at weekly intervals and analyzed for their pH using Orin Perphect Meter 370 and analyzed for their silver ion concentrations using atomic absorption spectrometry.

FIG. 6 shows a table containing a list of the dissolved silver concentration, in parts per billion (ppb) obtained from the 100 ml samples for solution “D” (without DMH) and solution “C” (with DMH) at each of their respective weekly time intervals. The average concentration of dissolved silver for solution “C” (with DMH) was 86 ppb while solution “D” (without DMH) had an average concentration of dissolved silver of 4.7 ppb.

A week after the start date, the concentration of dissolved silver for solution D (without DMH) was at 4.3 ppb, while the concentration of dissolved silver for solution C (with DMH) was at 2.8 ppb. By the end of the testing, 6 weeks later, the concentration of dissolved silver for solution C (with DMH) had increase to 220 ppb, while the concentration of dissolved silver for solution D (without DMH) was 7.1 ppb. That is, by the end of the 6 weeks test, the concentration of dissolved silver was at least 30-fold greater in solution C (with DMH) then for solution D, (without DMH).

In summary, the results of the above testing confirmed that in a solution containing silver bromide, the presence of compound containing a hydantoin ring, such as DMH, leads to a higher dissolved silver concentrations than compared to a control solution containing silver bromide without the presence of the DMH. These results suggest that compounds containing a hydantoin ring interact with silver to form a soluble complex even if the source of silver comprises an extremely insoluble silver salt such as silver bromide.

In regards to generating a level of silver ions, the King Technology, Inc. Frog® Mineral Cartridge provides one method of delivering silver ions in the form of solid silver chloride (AgCl) distributed over a porous matrix. The water releases the soluble silver ions into the water environment with the DMH resulting in the formation of ionic-hydantoin structures. It would be anticipated that soluble silver ions would be depleted from the water environment through the formation of silver bromide, an insoluble salt. However, as shown in FIG. 6 after the DMH was added to the water environment, the actual silver concentrations were higher than the calculated theoretical silver concentration.

It is noted that various insoluble or slightly soluble transition metal salts may also be used in the present invention as a source of silver ions. Examples of insoluble or slightly soluble transition metal salts suitable for use in the present invention include, but are not limited to, AgCl, AgBr, AgI, Ag₂S, Ag₃PO₄, NaAg₂PO₄, CuS, and NaCuPO₄. Other examples of silver compounds include, but are not limited to, AgNO₃, Ag₂CO₃, AgOAc, Ag₂SO₄, Ag₂O, [Ag(NH₃)₂]Cl, [Ag(NH₃)₂]Br, [Ag(NH₃)₂]I, [Ag(NH₃)₂]NO₃, [Ag(NH₃)₂]₂SO₄, silver acetoacetate a silver benzoate, a silver carboxylate, silver amine complexes such as [Ag(NR₃)₂]X, where R is an alkyl or aryl group or substituted alkyl or aryl group and X is an anion such as, but not limited to, Cl⁻, Br⁻, I⁻, OAc⁻, NO₃⁻ and SO₄²⁻.

Although the use of the silver ion donor such as silver, silver oxide, silver salt, or a combination thereof have been disclosed in the present invention, various types of silver alloys may also be used as a source of the silver ions. The silver may be used as a stand-alone or in its pure/elemental or alloyed form or coated or impregnated to a substrate and placed on the structure surface. In addition, to other types of silver ion donors, other types of transition metals, a transition metal oxide, or a combination thereof, and other alternative bactericides whose solubility can be changed in the presence of compound containing a hydantoin ring can also be used in the present invention.

In the example, the preferred level of the DMH present on the surface of the structure surface is at least 5 ppm and preferably between 5 and 25 ppm for most applications with the DMH and the source of silver cooperating to maintain a level of silver ions present in the amount of at least 1 to 3 ppb and/or alternatively cooperating to maintain a level of silver ions present to sustain a standard plate count at 35 degrees F. of less than 200 colonies per milliliter. However, as the test results show the level of silver can be much higher.

In one example the invention includes a structure surface sanitizing method where one forms a structure surface and applies an antimicrobial agent containing a source of metallic ions and a compound containing a hydantoin ring to the structure surface to thereby lessen or eliminate growth of bacteria and other harmful microorganisms on the structure surface.

The application of the antimicrobial agent to the structure surfaces may be done with a carrier such as a water base solution with the water allowed to evaporate leaving a coating of the antimicrobial agent on the structure surface.

In another example the structure surface may comprise building surfaces wherein the building surfaces includes a plurality of indoor and outdoor surfaces having an antimicrobial agent thereon wherein the antimicrobial agent including a biocidal metal and a compound containing a hydantoin ring have been incorporated directly into the structure surface through adhesives or pressure. The presence of a liquid such as water on the building surfaces causing an increase in the antimicrobial activity of the biocidal metal to lessen or destroy harmful bacteria or microorganisms thereon. In other examples the structure surface may be on items that are routinely used in the buildings or come into contact with structure surfaces such as brooms, appliances, vacuums, buckets, utensils, tools, garments and the like.

While the antimicrobial agent can be applied to a structure surface before the growth of bacteria or harmful organisms the antimicrobial agent may be applied to surface with bacteria and other harmful organisms are present. For example, the invention may include a method of treating a building product to kill microorganisms on a surface by: (1) adding a source of biocidal metal, such as silver chloride, to a water base to generate biocidal metal ions in the water; and (2) adding a compound having a hydantoin ring, such as 5,5-dimethylhydantoin to interact, with the biocidal metal to enhance the biocidal metal ion concentration before applying the antimicrobial agent to the surface to quickly kill bacteria and harmful microorganism thereon.

The aforementioned method of applying the antimicrobial agent may include the step of impregnating the building products prior to assembly of the building products and preferably at the point of manufacture. Alternately, the antimicrobial agent can be applied after construction through spraying or brushing the antimicrobial agent on to the structure surfaces. For example, structure surfaces such as keyboards for electronic devices may be sprayed with the antimicrobial agent to provide enhanced bacteria and microorganisms killing ability.

We claim:

1. An antimicrobial method for a structure surface comprising;
forming a structure surface;
applying an antimicrobial agent containing a source of metallic ions and a compound containing a hydantoin ring, which may or may not have antimicrobial properties, to the structure surface whereby the compound containing a hydantoin ring increases the availability of the metallic ions when the antimicrobial agent is in the presence of a liquid.

2. The antimicrobial method for a structure surface of claim 1 wherein the source of metallic ions in the antimicrobial agent includes a transition metal, a transition metal oxide, a transition metal salt, or a combination thereof.

3. The antimicrobial method for a structure surface of claim 2 wherein the step of adding the transition metal, the transition metal oxide, the transition metal salt, or a combination thereof to the comprises adding silver, silver oxide, silver salt, or a combination thereof to the antimicrobial agent before applying the antimicrobial agent to the structure surface.

4. The antimicrobial method for a structure surface of claim 1 including the step of increasing the effectiveness of the antimicrobial agent through introduction of water to the antimicrobial agent.

5. The antimicrobial method for a structure surface of claim 4 wherein the antimicrobial agent is a water base solution containing silver chloride and applying the water base solution containing the silver chloride and a compound containing a hydantoin ring to a structure surface and allowing the water base solution to evaporate to leave the antimicrobial agent in an activateable state.

6. The antimicrobial method for a structure surface of claim 5 wherein the step of adding the antimicrobial agent to the structure surfaces comprises applying the antimicrobial agent to the structure surface and then enclosing the structure surface.

7. The antimicrobial method for a structure surface of claim 1 wherein the compound containing a hydantoin ring is a halogenated hydantoin selected from the group consisting of Bromochlorodimethylhydantoin (BCDMH), Dichlorodimethylhydatoin (DCDMH), and Dibromodimethylhydantoin (DBDMH).

8. The antimicrobial method for a structure surface of claim 1 wherein the antimicrobial agent is applied to the structure surfaces a water base solution and the water is allowed to evaporate leaving a coating of the antimicrobial agent on the structure surface.

9. The antimicrobial method for a structure surface of claim 1 wherein the antimicrobial agent is incorporated into structure surface during formation of the structure surface.

10. A building wherein the building includes a plurality of indoor and outdoor surfaces each having a structure surface with an antimicrobial agent containing a biocidal metal and a compound containing a hydantoin ring wherein the antimicrobial level of the biocidal metal in the presence of water increases the ability of the antimicrobial agent to destroy harmful bacteria or microorganisms by increasing the availability of biocidal metal from the biocidal metal.

11. The building product of claim 10 wherein the building product surface is an integral component of a building.

12. The building product of claim 10 including a liquid on the structure surface whereby the liquid comprises a water based solution containing an antimicrobial agent and a compound containing a hydantoin ring.

13. The building product of claim 12 wherein the antimicrobial agent includes a source of silver ions.

14. The building product of claim 12 wherein the compound containing a hydantoin ring comprises 5,5-dimethylhydantoin and the biocidal metal comprises a source of silver.

15. A bacteria and microorganism killing zone proximate a structure surface wherein the killing zone includes a region on the structure surface; and
an antimicrobial agent located in the region on the structure surface with the antimicrobial agent including a source of metal ions and a compound containing a hydantoin ring, wherein the presence of water increase a level of metal ions in the killing zone.

16. The bacteria and microorganisms killing zone of claim 15 wherein the source of metal ions is silver chloride and the compound containing the hydantoin ring is dimethylhydantoin.

17. The bacteria and microorganisms killing zone of claim 15 wherein the antimicrobial agent adheres to the structure surface and the region on the structure surface includes a water wetted structure surface whereby the level of metal ions in the water wetted structure surface is greater than if the surface were unwetted.

18. The bacteria and microorganisms killing zone of claim 17 wherein the water-wetted structure is an interior building surface.

19. The bacteria and microorganisms killing zone of claim 17 wherein the bacteria and microorganisms killing zone expands or contracts in response to an area of the water wetted structure surface.

20. The structure surface antimicrobial method of claim 1 wherein the structure surface is an article of furniture and the step of treatment to lessen or prevent growth of bacteria includes of applying an antimicrobial agent to the structure surface wherein the antimicrobial agent includes a biocidal meal and a compound containing a hydantoin ring.
